(19) United States
(12) Patent Application Publication
(10) Pub. No.: US 2002/0151317 A1
(43) Pub. Date: Oct. 17, 2002

(54) Pager system

(76) Inventors: Wolfgang Wippich, Hersbruck (DE); Eckhard Walters, Roethenbach (DE)

Correspondence Address: Michael E. Marion, c/o U.S. PHILIPS CORPORATION, Intellectual Property Department, 580 White Plains Road, Tarrytown, NY, 10591, US

(21) Appl. No.: 10/105,458

(22) Filed: Mar. 25, 2002

(30) Foreign Application Priority Data
Mar. 28, 2001 (DE) 10115343.0

(51) Int. Cl. H04Q 7/20

(52) U.S. Cl. 455/466; 455/574

(57) ABSTRACT

A pager system which includes a base transceiver station (2) for the wireless transmission of data in conformity with the GSM standard, an SMS center (5) for the storage of pager short messages, which center is connected to the base transceiver station (2) so as to transmit data, and at least one pager device (9) which includes a transmit/receive unit (2) which operates in conformity with the GSM standard for the wireless reception of pager short messages from the base transceiver station (2), an output unit (15) which is connected to the transmit/receive unit (10) so as to transmit data for the display of the pager short messages received, and a power consumption control unit which is constructed in such a manner that it switches over the pager system (1) from a normal mode of operation to a power saving mode for selectable periods of time.

The invention relates to a pager system for the transmission of pager short messages.

A stationary transmitter communicates with a multitude of pager devices in the case of conventional pager systems. The transmitter continuously transmits the messages to be transmitted and the relevant pager device is continuously ready to receive and displays a message received. The foregoing has the drawback that the realization of pager services and the construction of pager networks have not progressed very far and still are very expensive, notably in less developed countries.

It is an object of the invention to provide a pager system that saves on energy.

The object is achieved as disclosed in the characterizing part of claim 1. The basic idea of the invention is to use an SMS message system in conformity with the GSM standard of mobile networks for the transmission of pager short messages. The pager device then switches over regularly from a normal mode of operation to a power saving mode.

Further attractive embodiments of the invention are disclosed in the dependent claims.

Additional features and details of the invention will become apparent from the following description of two embodiments which is given with reference to the drawing. Therein:

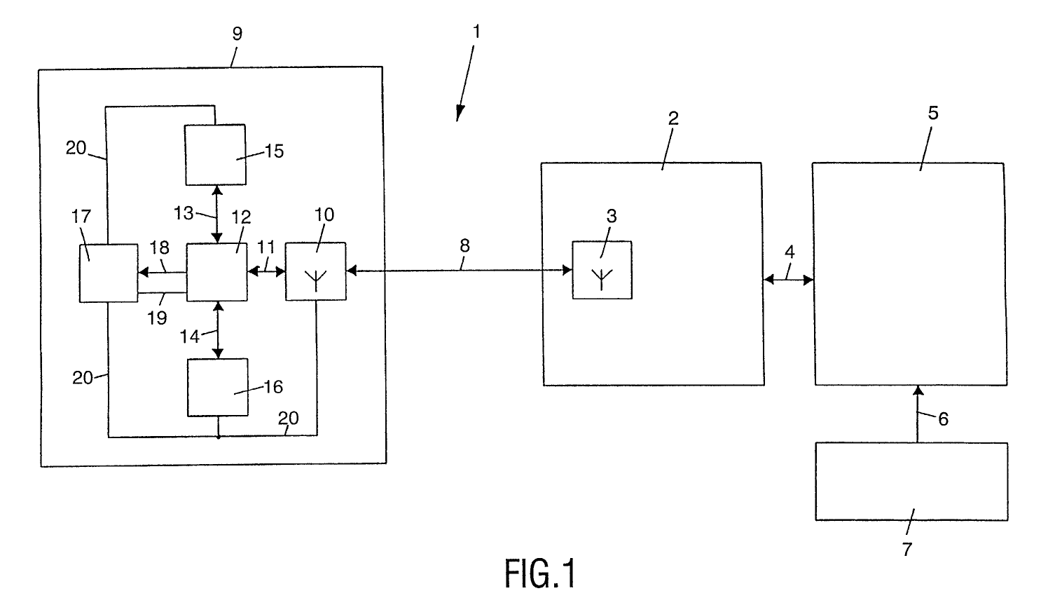

FIG. 1 is a diagrammatic representation of a first embodiment of a pager system, and

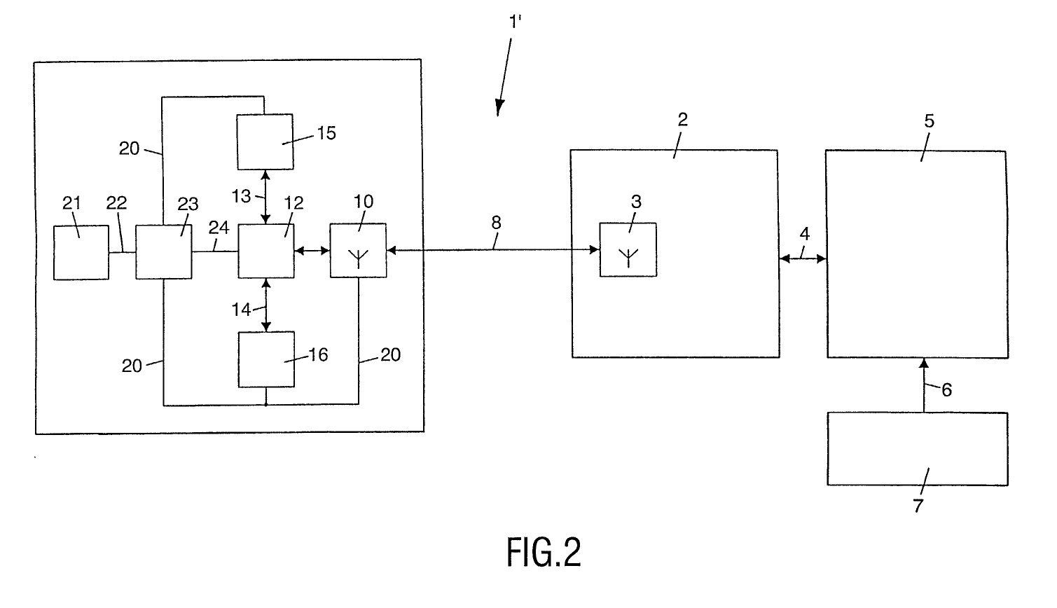

FIG. 2 is a diagrammatic representation of a second embodiment of a pager system.

A first embodiment of the invention will be described in detail hereinafter with reference to FIG. 1. A pager system 1 comprises a stationary base transceiver station 2 which includes a transmit/receive unit 3. The base transceiver station 2 is a regular base station of a mobile radio network which operates in conformity with the GSM standard. The construction of such a station 2 is generally known. An SMS center 5 is connected to the base transceiver station 2 via a data link 4. The SMS center 5 is a unit for storing short messages, that is, so-called SMS (Short Message Service) messages. The SMS center 5 is used to buffer pager messages. The SMS center 5 is connected, via a data link 6, to an input unit 7 for the input of pager short messages. The base transceiver station 2, the SMS center 5 and the input unit 7, a number of which may be distributed across the country in a pager system 1, constitute the stationary backbone of the pager system 1.

The base transceiver station 2 communicates, via a radio link 8, with a plurality of pager devices 9, only one of which is shown in FIG. 1. Generally speaking, the devices 9 are small and easy to handle. A pager device 9 includes a transmit/receive unit 10 which communicates, via the radio link 8, with the transmit/receive unit 3 in conformity with the GSM standard. The transmit/receive unit 10 is connected, via a data lead 11, to the central data processing unit (CPU) 12. The data processing unit 12 is connected, via further leads 13, 14, to an input/output unit 15 and a storage unit 16. The input/output unit 15 comprises a keyboard for input and a display for output, notably a liquid crystal display. It is feasible to provide only an output unit 15 for the display of the pager short messages. There is also provided a clock control power supply unit 17 which is constructed as a power consumption control unit and is connected, via a switching/control lead 18, to the data processing unit 12. The leads 11, 13, 14, 18 serve primarily for the transmission of data. The clock control power supply unit 17 is connected to the data processing unit 12 via a clock/voltage supply lead 19. The clock control power supply unit 17 is also connected, via clock/voltage supply leads 20 and 21, to the input/output unit 15 and the storage unit 16 and the transmit/receive unit 10. The leads 19, 20 and 21 serve for the clock and voltage supply for the previously mentioned components.

The operation of the pager system 1 will be described in detail hereinafter. Pager short messages are input by the input unit 7 and transferred to the SMS center 5, via the data connection 6, so as to be buffered therein. The pager device 9 switches over its operating state to the normal mode of operation at regular time intervals, in response to which the transmit/receive unit 10 of the pager device 9 establishes the BTS link with the transmit/receive unit 3 in conformity with the protocol of the GSM standard, thus indicating the availability of the pager device 9. The base transceiver station 2 can then forward the information concerning the availability of the pager device 9 to the SMS center 5 so as to trigger the transmission of waiting pager messages. In case pager messages are present, the stored pager messages are fetched from the SMS center 5, via the data link 4, and transferred to the pager device 9 via the radio link 8, said messages being displayed and/or stored in the storage unit 6 therein via the data processing unit 12. After a predetermined period of time, the clock control power supply unit 17 is instructed, via the central data processing unit 12, to switch the system clock to a lower frequency so that less power is consumed. The central data processing unit 12 can also instruct the clock control power supply unit 17 to interrupt the clock supply for the individual components 10, 16, 15. This power saving mode is sustained for a fixed period of time, after which the normal mode of operation is automatically restored. The pager device 9 can thus be constructed so as to be smaller, for the same time of operation without recharging, or the standby time can be increased accordingly. A principal advantage of the pager system 10 resides in the fact that in regions in, for example, the second and the third world where the construction of a pager system would be too expensive, use can be made of existing mobile radio networks operating on the basis of the GSM standard. Therefore, paging services can also be established in such countries. A further advantage relates to the fact that according to customary protocols the messages are not transmitted in encrypted form. In the case of transmissions in conformity with the GSM standard, however, they are. Additional confidentiality is thus offered. Moreover, customary pager devices require continuous reception so as to receive pager short messages coming in via a fixed, predetermined channel.

A second embodiment of the invention will be described in detail hereinafter with reference to FIG. 2. Identical parts bear the same reference numerals as used in the first embodiment; for these parts reference is made to the above description. Structurally different but functionally similar components bear the same reference numerals provided with a superscript stroke. The principal difference resides in the construction of the power consumption control unit which is formed by a power supply unit 21 and a switch-on/off control unit 23 which is connected via a voltage supply lead 22. The unit 23 is also responsible for the clock supply. The unit 23 is connected, via a data-control lead 24, to the central data processing unit 12. The switch-on/off control unit 23 permanently receives a current via the lead 22. The unit 23 then supplies the units 10, 12, 15 and 16 with current and the system clock and can autonomously influence the power supply or the supply with the system clock. Upon switching over from the normal mode of operation to the power saving mode, the unit 23 reduces or interrupts the current and/or system clock supply. It is also advantageous that only a comparatively small amount of power is consumed during operation of the pager device 9, so that the advantages described for the first embodiment are retained.

1. A pager system which includes
a) a base transceiver station (2) for the wireless transmission of data in conformity with the GSM standard,
b) an SMS center (5) for storing pager short messages which is connected to the base transceiver station (2) so as to transmit data, and
c) at least one pager device (9) which includes
i) a transmit/receive unit (10) which operates in conformity with the GSM standard for the wireless reception of pager short messages from the base transceiver station (2),
ii) an output unit (15) which is connected to the transmit/receive unit (10) so as to transmit data in order to display the received pager short messages, and
iii) a power consumption control unit which is constructed in such a manner that it switches over from a normal mode of operation to a power saving mode for predetermined periods of time.

2. A pager system as claimed in claim 1, characterized in that there is provided an input unit (7) which is connected to the SMS center (5) so as to transmit data for the input of pager short messages.

3. A pager system as claimed in claim 1 or 2, characterized in that there is provided a central data processing unit (12) which is connected to the transmit/receive unit (10) and the output unit (15) so as to transmit data.

4. A pager system as claimed in claim 3, characterized in that the power consumption control unit includes a clock control unit (17) for influencing the clock frequency.

5. A pager system as claimed in claim 3 or 4, characterized in that the power consumption control unit separates the transmit/receive unit (10) and/or the output unit (15) and/or the central data processing unit (12) from the power supply for selectable periods of time.

6. A pager system as claimed in one of the claims 3 to 5, characterized in that the central data processing unit (12) controls the transmit/receive unit (10) in such a manner that, in the case of the normal mode of operation, it interrogates the base transceiver station (2) as to whether pager short messages are stored in the SMS center (5), said messages being subsequently transmitted from the base transceiver station (2) to the transmit/receive unit (10).

7. A pager system as claimed in claim 3, characterized in that the power consumption control unit includes a power supply unit (17; 21).

8. A pager system as claimed in claim 7, characterized in that the power consumption control unit includes a switch-on/off control unit (23) which is electrically conductively connected to the power supply unit (21).

9. A pager system as claimed in claim 8, characterized in that the switch-on/off control unit (23) is constructed in such a manner that it ensures switching over from the normal mode of operation to the power saving mode and vice versa.

10. A pager system as claimed in one of the preceding claims, characterized in that there is provided a storage unit (16) which is connected to the central data processing unit (12) so as to transmit data for the storage of pager short messages.
